(19) United States
(12) Patent Application Publication
(10) Pub. No.: US 2026/0038802 A1
(43) Pub. Date: Feb. 5, 2026

(54) ELECTRODE LAYER, SECONDARY BATTERY INCLUDING THE SAME, AND METHOD FOR MANUFACTURING THE SAME

(71) Applicant: ELECTRONICS AND TELECOMMUNICATIONS RESEARCH INSTITUTE, Daejeon (KR)

(72) Inventors: Ju Young KIM, Daejeon (KR); Young-Gi LEE, Daejeon (KR); Jaecheol CHOI, Daejeon (KR); Seok Hun KANG, Daejeon (KR); Yunho LEE, Daejeon (KR)

(21) Appl. No.: 19/277,977

(22) Filed: Jul. 23, 2025

(30) Foreign Application Priority Data
Jul. 31, 2024 (KR) 10-2024-0101530
Jul. 17, 2025 (KR) 10-2025-0096917

(51) Int. Cl. H01M 4/131; H01M 4/02; H01M 4/04; H01M 4/1391; H01M 4/62; H01M 4/66; H01M 50/417; H01M 50/489

(52) U.S. Cl. CPC H01M 4/131; H01M 4/0402; H01M 4/1391; H01M 4/622; H01M 4/625; H01M 4/66; H01M 50/417; H01M 50/489; H01M 2004/021

(57) ABSTRACT

Provided is an electrode layer including a hydrophobic separator including a first surface and a second surface opposite to each other, a first active material layer on the first surface of the separator, and a second active material layer on the second surface of the separator, wherein the first active material layer includes a first active material, a first binder including a polyvinyl alcohol-based polymer, a second binder including a material different from that of the first binder, and a conductive material having a ratio of the length of a long axis to the length of a short axis of approximately 2 or greater, and the second active material layer includes a second active material, the first binder, the second binder, and the conductive material, and the electrode layer does not include a metal current collector.

### CROSS-REFERENCE TO RELATED APPLICATIONS

This U.S. non-provisional patent application claims priority under 35 U.S.C. § 119 of Korean Patent Application Nos. 10-2024-0101530, filed on Jul. 31, 2024, and 10-2025-0096917, filled on Jul. 17, 2025, the entire contents of which are hereby incorporated by reference.

### BACKGROUND

### 1. Field of the Invention

The present disclosure herein relates a secondary battery, and more particularly, to a secondary battery not including a current collector.

### 2. Description of Related Art

A secondary battery, particularly a lithium ion secondary battery, is an energy storage device exhibiting a high energy capacity and stable output characteristics, and is variously applied to an electric vehicle, an energy storage system, and the like in a portable power source. However, due to the difficulty of developing new materials, limitations of available energy storage mechanisms, and the like, the energy density of the lithium ion secondary battery has reached its limit. In order to address this issue, a next-generation battery using a new electrochemical reaction has been developed, which corresponds to a lithium-sulfur secondary battery, a lithium metal secondary battery, an all-solid-state battery, and the like. However, in the case of such a new battery, there are various issues that need to be resolved before commercialization, and there still remains a fundamental question about whether the energy density theoretically calculated can be actually implemented.

One of the other methods capable of improving the energy density of the lithium ion secondary battery is a method of reducing the configuration of a typical lithium ion secondary battery, thereby reducing the weight or volume of the secondary battery without significantly affecting the energy that can be implemented. Typically, the above-described purpose can be achieved by using a thin separator or current collector. However, this approach may reduce the mechanical stability of the separator and the current collector, thereby allowing the separator to be torn by an external stimulus during the driving of a secondary battery, which may cause abnormal behaviors such as sudden explosion of the secondary battery, resulting in threatening the safety of a user, or allowing the current collector to be torn during the application of an electrode layer on the current collector, which may hinder the smooth manufacturing of an electrode. In addition, research has been proposed on using a lightweight metal and modifying a metal surface by a method such as plating the corresponding metal surface to induce a stable electrochemical reaction, and research has also been reported on using a patterned current collector to reduce the weight of the current collector. Despite various research activities, there is still a lack of research that achieves an effect of simultaneously improving productivity, maximized energy density, and the like.

### SUMMARY

The present disclosure provides a secondary battery not including a current collector.

The present disclosure also provides a secondary battery with increased energy density.

The present disclosure also provides an easily recyclable secondary battery.

An embodiment of the inventive concept provides an electrode layer including a hydrophobic separator including a first surface and a second surface opposite to each other, a first active material layer on the first surface of the separator, and a second active material layer on the second surface of the separator, wherein the first active material layer includes a first active material, a first binder including a polyvinyl alcohol-based polymer, a second binder including a material different from that of the first binder, and a first conductive material having a ratio of the length of a long axis to the length of a short axis of approximately 2 or greater, and the second active material layer includes a second active material, a third binder including a polyvinyl alcohol-based polymer, a fourth binder being hydrophilic and including a material different from that of the third binder, and a second conductive material having a ratio of the length of a long axis to the length of a short axis of approximately 2 or greater, and the electrode layer does not include a metal current collector.

In an embodiment, the electrode layer may include a first separator including a first surface and a second surface opposite to each other, and a plurality of first active material layers disposed on the first surface and the second surface of the first separator, wherein each of the plurality of first active material layers may include a first binder including a first active material and a polyvinyl alcohol-based polymer, a second binder including a material different from that of the first binder, and a first conductive material having a ratio of the length of a long axis to the length of a short axis of approximately 2 or greater, and the electrode layer may not include a metal current collector.

In an embodiment of the inventive concept, a method for manufacturing a secondary battery includes preparing a first slurry including a first active material, a first binder including a polyvinyl alcohol-based polymer, a first conductive material, and a second binder, preparing a second slurry including a second active material, a third binder including a polyvinyl alcohol-based polymer, a second conductive material, and a fourth binder, applying the first slurry on a first surface of a separator, applying the second slurry on a second surface of the separator, drying the first slurry, thereby forming a first active material layer, and drying the second slurry, thereby forming a second active material layer, wherein each of the first conductive material and the second conductive material has a ratio of the length of a long axis to the length of a short axis of approximately 2 or greater.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a cross-sectional view of a secondary battery according to embodiments of the inventive concept;

FIG. 2A is an enlarged view of portion a of FIG. 1;

FIG. 2B is an enlarged view of portion b of FIG. 1;

FIG. 2C is an enlarged view of portion c of FIG. 1;

FIG. 3 is an enlarged view of a high-aspect ratio conductive material according to embodiments of the inventive concept;

FIG. 4 is a cross-sectional view of a secondary battery according to some embodiments of the inventive concept;

FIG. 5 is a schematic view of a secondary battery analysis platform according to some embodiments of the inventive concept;

FIG. 6 is the result of capturing photographs of embodiments of the inventive concept;

FIG. 7 is the result of energy dispersive X-ray spectroscopy of embodiments of the inventive concept;

FIG. 8 is the result of evaluating charge/discharge of Example 3;

FIG. 9 is the result of evaluating charge/discharge of Comparative Example 4;

FIG. 10 is the result of evaluating electronic conductivity of Example 3 and Comparative Example 4;

FIG. 11 is the result of changes in the open circuit voltage of Example 3 and Comparative Example 4;

FIG. 12 is the result of evaluating the capacity and the Coulombic efficiency of Example 3 and Comparative Example 4;

FIG. 13 is the result of evaluating charge/discharge of Example 3 and Comparative Example 4;

FIG. 14 is the result of evaluating electronic conductivity of Example 3 and Comparative Example 4;

FIG. 15 is the result of changes in open circuit voltage of Example 3 and Comparative Example 4;

FIG. 16 is the result of capturing scanning electron microscopy and energy dispersive X-ray spectroscopy of Example 7;

FIG. 17 is the result of evaluating a negative electrode layer of Example 7;

FIG. 18 is the result of evaluating a negative electrode layer of Example 7;

FIG. 19 is the result of evaluating a negative electrode layer of Example 7;

FIG. 20 is the result of evaluating a negative electrode layer of Example 7;

FIG. 21 is the result of evaluating a negative electrode layer of Example 7;

FIG. 22 is the result of evaluating a negative electrode layer of Example 7;

FIG. 23 is the result of evaluating a negative electrode layer of Example 7;

FIG. 24 is the result of evaluating a negative electrode layer of Example 7;

FIG. 25 is the result of evaluating a negative electrode layer of Example 7;

FIG. 26 is the result of evaluating stacked anode layers of Example 7;

FIG. 27 is the result of evaluating stacked anode layers of Example 7;

FIG. 28 and FIG. 29 are the results of evaluating thermal stability of Examples and Comparative Examples;

FIG. 30 is the result of evaluating the separation of an electrode layer according to Example 7;

FIG. 31 shows the result of analyzing an active material layer through an analysis system according to embodiments of the inventive concept; and

FIG. 32 and FIG. 33 are views showing an electrode layer on which a tab is formed according to embodiments of inventive concept.

### DETAILED DESCRIPTION OF THE INVENTION

Hereinafter, embodiments of the inventive concept will be described with reference to the accompanying drawings to describe the inventive concept in detail.

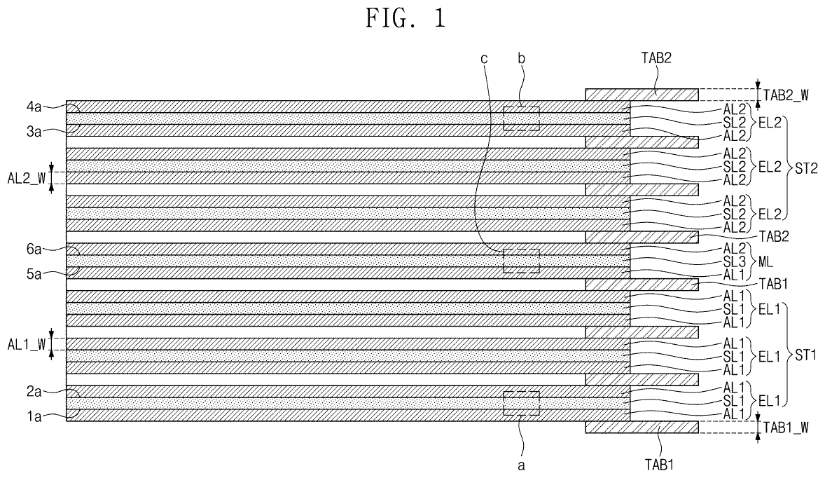

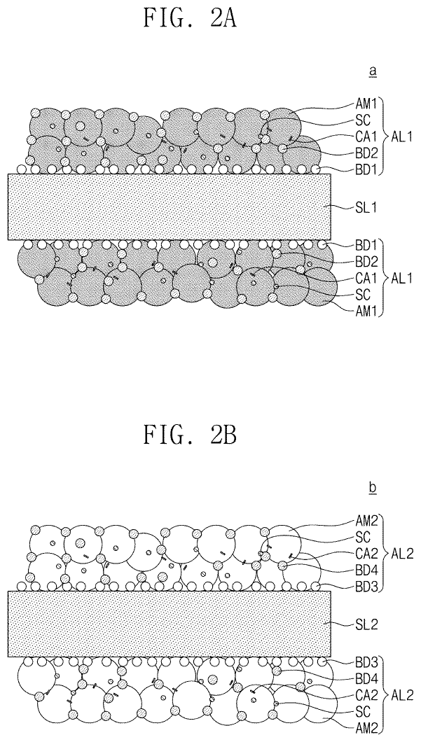

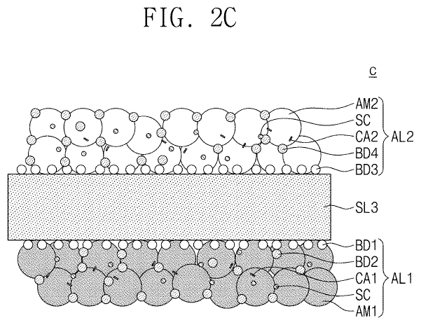

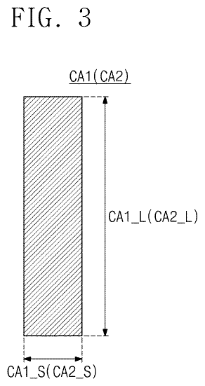

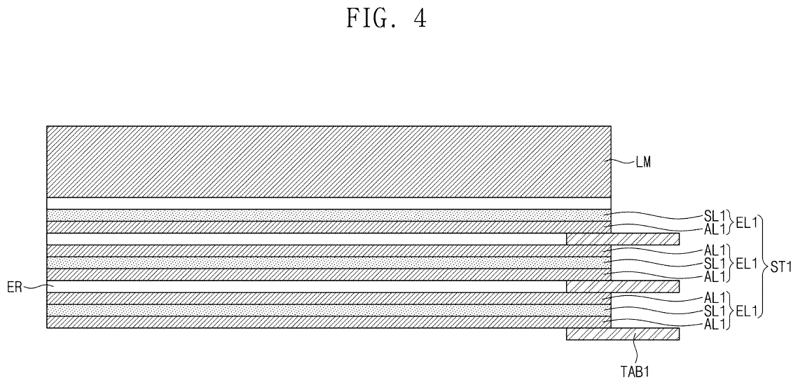

FIG. 1 is a cross-sectional view of a secondary battery according to embodiments of the inventive concept. FIG. 2A is an enlarged view of portion a of FIG. 1. FIG. 2B is an enlarged view of portion b of FIG. 1. FIG. 2C is an enlarged view of portion c of FIG. 1. FIG. 3 is an enlarged view of a conductive material according to embodiments of the inventive concept.

Referring to FIGS. 1, 2A, 2B, 2C, and 3, the secondary battery according to embodiments of the inventive concept may include a first stack ST1, a second stack ST2, an intermediate electrode layer ML interposed between the first stack ST1 and the second stack ST2, and an electrolyte filling a space between the first stack ST1 and the second stack ST2.

The first stack ST1 may include a plurality of first electrode layers EL1. The plurality of first electrode layers EL1 may be in contact with each other. The plurality of first electrode layers EL1 may be electrically connected to each other. As a result, a secondary battery with improved energy density may be provided.

The plurality of first electrode layers EL1 may each include a first separator SL1 including a first surface 1a and a second surface 2a opposite to each other. The first separator SL1 may be a hydrophobic separator, and may be a porous separator. The first separator SL1 may have a porosity of, for example, 20 vol % to 50 vol % based on a total of 100 vol % of the first separator SL1. If the porosity is greater than 50 vol %, the mechanical stability of the secondary battery may be reduced. If the porosity is less than 20 vol %, ion conduction within the first separator SL1 is low, so that the battery performance may be reduced. The first separator SL1 may include, for example, a polyolefin-based polymer.

Each of the plurality of first active material layers AL1 may be disposed on each of the first surface la and the second surface 2a. Each of the plurality of first active material layers AL1 may have a thickness AL1_W of 50 μm to 350 μm. The thickness may mean a thickness in a direction perpendicular to the surface of the first separator SL1. Each of the plurality of first active material layers AL1 may be separated from the first separator SL1 at a high temperature. Each of the plurality of first active material layers AL1 may be separated from the first separator SL1 at a temperature higher than 150° C. A first active material layer LL1 disposed at the outermost periphery (e.g., the lowermost portion) among the plurality of first active material layers AL1 may be exposed to the outside.

Each of the plurality of first active material layers AL1 may include a first active material AM1, a first binder BD1, a second binder BD2, and a first conductive material CA1. Each of the plurality of first active material layers AL1 may have an electronic conductivity of 5 S/cm or greater.

The first active material AM1 may be, for example, a positive electrode active material. The first active material AM1 may include, for example, a lithium transition metal oxide. The first active material AM1 may include, for example, any one or more selected from the group consisting of LiCoO₂, LiNiO₂, LiNiₓCo_{y}Mn_{z}O₂ (x+y+z=1, NCMxyz), LiMn₂O₄, LiFePO₄, and a combination thereof. The first active material AM1 may have a content of 80 wt % to 98 wt % based on 100 wt % of the first active material layer. The first active material layer AL1 may have a capacity per unit area of 1.5 mAh/cm² to 3.5 mAh/cm². The first stack ST1 in which the plurality of first active material layers AL1 are stacked may have a capacity per unit area of 4 mAh/cm² or greater.

The first binder BD1 may include a polyvinyl alcohol-based polymer. The first binder BD1 may be physically adsorbed onto the surface of the first separator SL1. The first binder BD1 may be physically adsorbed in pores of the first separator SL1, which have a large surface area. The surface of the first separator SL1 may be hydrophilically modified by the first binder BD1. The surface of the first separator SL1 may be hydrophilically modified by a hydroxyl group (13 OH), which is a hydrophilic functional group of the first binder BD1. The first binder BD1 may have a content of 0.1 wt % to 5 wt % based on 100 wt % of each of the plurality of first active material layers AL1. Each of the plurality of first active material layers AL1 may be uniformly disposed on the surface of the first separator SL1.

The second binder BD2 may include a material different from that of the first binder BD1. The second binder BD2 may include, for example, an aqueous polymer. The second binder BD2 of each of the plurality of first active material layers AL1 may have a content of 0.1 wt % to 5 wt % based on 100 wt % of each of the plurality of first active material layers AL1. Due to the second binder BD2, the binding force between the first separator SL1 and each of the plurality of first active material layers AL1 may increase. Due to the second binder BD2, the binding force of particles in the plurality of first active material layers AL1 may increase.

The second binder BD2 may include, for example, one or more selected from the group consisting of polyethylene oxide (PEO), polyvinyl pyrrolidone (PVP), polyacrylamides, poly N-(2-Hydroxypropyl) methacrylamide (HPMA), polyethyleneimine (PEI), polyacrylic acid (PAA), divinyl ether-maleic anhydride, polyoxazoline, polyphosphates, polyphosphazenes, xanthan gum, pectins, dextran, carrageenan, guar gum, sodium carboxymethyl cellulose, styrene-butadiene rubber, sodium alginate, hyaluronic acid, albumin, and a combination thereof.

The first conductive material CA1 may have a ratio of the length of a long axis CA1_L to the length of a short axis CA1_S of 2 or greater. That is, the first conductive material CA1 according to embodiments of the inventive concept may be a high-aspect ratio conductive material. The first conductive material CA1 may have a content of 0.1 wt % to 10 wt % based on 100 wt % of each of the plurality of first active material layers AL1. The first conductive material CA1 may include, for example, at least one of carbon nanotubes, graphene, and graphite.

Each of the plurality of first active material layers may include a conductive material SC in a dot shape. The conductive material SC in a dot shape may include, for example, carbon black. Each of the plurality of first active material layers includes the conductive material SC in a dot shape, and thus, may have various electronic conduction paths.

According to embodiments of the inventive concept, an active material layer having high electronic conductivity may be provided by including a high-aspect ratio conductive material. In the case of a high-aspect ratio conductive material, an electronic conduction path is limited to a material connected in atomic units, and thus, may not be affected by formation of by-products due to electrolyte decomposition. Therefore, even if the secondary battery is continuously charged and discharged, stable electronic conductivity characteristics may be provided.

A first tab TAB1 may be disposed on each of the plurality of first active material layers AL1. The first stack ST1 may be electrically connected to the outside through the first tab TAB1. The first tabs TAB1 may be electrically connected to each other externally. The first tabs TAB1 may form an integral body externally. The first tab TAB1 may have a thickness TAB1_W of 100 μm or less, and may be a non-reactive metal. The first tab TAB1 may include, for example, nickel, aluminum, and the like.

The second stack ST2 may include a plurality of second electrode layers EL2. The plurality of second electrode layers EL2 may be in contact with each other. The plurality of second electrode layers EL2 may be electrically connected to each other. As a result, a secondary battery with improved energy density may be provided.

The plurality of second electrode layers EL2 may each include a second separator SL2 including a third surface 3a and a fourth surface 4a opposite to each other. The second separator SL2 may be a hydrophobic separator, and may be a porous separator. The second separator SL2 may have a porosity of, for example, 20 vol % to 50 vol % based on a total of 100 vol % of the second separator SL2. If the porosity is greater than 50 vol %, the mechanical stability of the secondary battery may be reduced. If the porosity is less than 20 vol %, ion conduction within the second separator SL2 is low, so that the battery performance may be reduced. The second separator SL2 may include, for example, a polyolefin-based polymer.

Each of the plurality of second active material layers AL2 may be disposed on each of the third surface 3a and the fourth surface 4a. Each of the plurality of second active material layers AL2 may have a thickness AL2_W of 50 μm to 350 μm. A second active material layer UL2 disposed at the outermost periphery (e.g., the uppermost portion) among the plurality of second active material layers may be exposed to the outside.

Each of the plurality of second active material layers AL2 may be separated from the second separator SL2 at a high temperature. Each of the plurality of second active material layers AL2 may be separated from the second separator SL2 at a temperature higher than 150° C.

Each of the plurality of second active material layers AL2 may include a second active material AM2, a third binder BD3, a fourth binder BD4, and a second conductive material CA2. Each of the plurality of second active material layers AL2 may have an electronic conductivity of 5 S/cm or greater.

The second active material AM2 may be, for example, a negative electrode active material. The second active materials AM2 may include, for example, any one or more selected from the group consisting of silicon, tin, graphite, lithium, and a combination thereof. The second active material layer AL2 may have a capacity per unit area of 1.5 mAh/cm² to 3.5 mAh/cm². The second stack ST2 in which the plurality of second active material layers AL2 are stacked may have a capacity per unit area of 4 mAh/cm² or greater.

The third binder BD3 may include a polyvinyl alcohol-based polymer. The third binder BD3 may be physically adsorbed onto the surface of the second separator SL2. The third binder BD3 may be physically adsorbed in pores of the second separator SL2, which have a large surface area. The surface of the second separator SL2 may be hydrophilically modified by the third binder BD3. The surface of the second separator SL2 may be hydrophilically modified by a hydroxyl group (—OH), which is a hydrophilic functional group of the first binder BD1. Each of the plurality of second active material layers AL2 may be uniformly disposed on the surface of the second separator SL2.

The fourth binder BD4 may include a material different from that of the third binder BD3. The fourth binder BD4 may include, for example, an aqueous polymer. The fourth binder BD4 may have a content of 0.1 wt % to 5 wt % based on 100 wt % of each of the plurality of second active material layers AL2. Due to the fourth binder BD4, the binding force between the second separator SL2 and each of the plurality of second active material layers AL2 may increase. Due to the fourth binder BD4, the binding force of particles in the plurality of second active material layers AL2 may increase. The fourth binder BD4 may include a material same as that of the second binder BD2.

The second conductive material CA2 may have a ratio of the length of a long axis CA2_L to the length of a short axis CA2_S of 2 or greater. That is, the second conductive material CA2 according to embodiments of the inventive concept may be a high-aspect ratio conductive material. The second conductive material CA2 may have a content of 0.1 wt % to 10 wt % based on 100 wt % of each of the plurality of second active material layers AL2. The second conductive material CA2 may include a material same as that of the first conductive material CA1.

Each of the plurality of second active material layers AL2 may include a conductive material SC in a dot shape. The conductive material SC in a dot shape may include, for example, carbon black. Each of the plurality of second active material layers AL2 includes the conductive material SC in a dot shape, and thus, may have various electronic conduction paths.

A second tab TAB2 may be disposed on each of the plurality of second active material layers AL2. The second tab TAB2 may be electrically connected to the plurality of second active material layers AL2. The second stack ST2 may be electrically connected to the outside through the second tab TAB2. The second tabs TAB2 may be electrically connected to each other externally. The second tabs TAB2 may form an integral body externally. The second tab TAB2 may have a thickness TAB2_W of 100 μm or less, and may be a non-reactive metal. The second tab TAB2 may include, for example, copper, nickel, and the like.

According to embodiments of the inventive concept, a metal current collector may not be included. The first tab TAB1 and the second tab TAB2 may be respectively disposed on the first active material layer AL1 and the second active material layer AL2. A secondary battery having an increased amount of active material per unit weight may be provided by not including a current collector. Therefore, a secondary battery with increased energy density may be provided.

The intermediate electrode layer ML may include a third separator SL3 including a fifth surface 5a and a sixth surface 6a opposite to each other. The fifth surface 5a may face the first stack ST1, and the sixth surface 6a may face the second stack ST2.

The third separator SL3 may be a hydrophobic separator, and may be a porous separator. The third separator SL3 may have a porosity of, for example, 20 vol % to 50 vol % based on a total of 100 vol % of the first separator SL1. If the porosity is greater than 50 vol %, the mechanical stability of the secondary battery may be reduced. If the porosity is less than 20 vol %, ion conduction within the third separator SL3 is low, so that the battery performance may be reduced. The third separator SL3 may include, for example, a polyolefin-based polymer.

The first active material layer AL1 may be disposed on the fifth surface 5a. The first active material layer AL1 on the fifth surface 5a of the intermediate electrode layer ML may be electrically connected to the first stack ST1. The second active material layer AL2 may be disposed on the sixth surface 6a. The second active material layer AL2 on the sixth surface 6a of the intermediate electrode layer ML may be electrically connected. Each of the first active material layer AL1 and the second active material layer AL2 may be separated from the third separator SL3 at a high temperature. Each of the first active material layer AL1 and the second active material layer AL2 may be separated from the third separator SL3 at a temperature higher than 150° C.

The first tab TAB1 may be disposed on the first active material layer AL1 of the intermediate layer ML. The second tab TAB2 may be disposed on the second active material layer AL2 of the intermediate layer ML. As described above, the first tabs TAB1 may form an integral body with each other externally. The second tabs TAB2 may form an integral body with each other externally.

According to embodiments of the inventive concept, the active material layers AL1 and AL2 may be easily separated from the separators SL1, SL2, and SL3 at a critical temperature (e.g., 150° C.) or higher. The active material layers AL1 and AL2 may be easily recyclable.

An electrolyte ER may fill a space between the first stack ST1 and the second stack ST2, a space between the first stack ST1 and the intermediate electrode layer ML, and a space between the second stack ST2 and the intermediate electrode layer ML. The electrolyte ER may fill a space between the plurality of first active material layers AL1, and a space between the plurality of second active material layers AL2. The first separator SL1, the second separator SL2, and the third separator SL3 may be impregnated in the electrolyte ER. The electrolyte ER may be a liquid electrolyte and may include a lithium salt and an organic solvent. The lithium salt may include, for example, one or more selected from the group consisting of LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, LiC₄BO₈, and a combination thereof. The solvent may include, for example, any one or more selected from the group consisting of cyclic carbonate, linear carbonate, and a combination thereof. The cyclic carbonate may include, for example, any one or more selected from the group consisting of butylene carbonate, ethylene carbonate, propylene carbonate, glycerin carbonate, vinylene carbonate, fluoroethylene carbonate, and a combination thereof. The linear carbonate may include, for example, one or more selected from the group consisting of dimethyl carbonate, diethyl carbonate, ethyl methyl carbonate, dimethoxyethane, dimethyl ethylene carbonate, and a combination thereof. Furthermore, the solvent may include one or more selected from the group consisting of dimethyl sulfoxide, acetonitrile, sulfolane, dimethylsulfoxide, tetrahydrofuran, and a combination thereof. The lithium salt in the electrolyte ER may have a concentration of approximately 1 M to approximately 5 M.

The secondary battery according to embodiments of the inventive concept may have various shapes. For example, the secondary battery may be provided in a cylindrical shape or a pouch shape.

Referring back to FIG. 1, FIG. 2A, FIG. 2B, FIG. 2C, and FIG. 3, a method for manufacturing a secondary battery according to embodiments of the inventive concept will be described. In order to simply the description, the same descriptions as those of the secondary battery described with reference to FIG. 1, FIG. 2A, FIG. 2B, FIG. 2C, and FIG. 3 will be omitted.

A first slurry including a first active material AM1, a first binder BD1 including a polyvinyl alcohol-based polymer, a first conductive material CA1, a second binder BD2, and water as a solvent may be prepared. The first active material AM1 may have a content of 80 wt % to 98 wt % based on 100 wt % of the first slurry. The first binder BD1 may have a content of 0.1 wt % to 5 wt % based on 100 wt % of the first slurry. The second binder BD2 may have a content of 0.1 wt % to 5 wt % based on 100 wt % of the first slurry. The first conductive material CA1 may have a content of 0.1 wt % to 10 wt % based on 100 wt % of the first slurry. The first slurry may have a viscosity at room temperature (e.g., 25° C.) of 100 cP to 100,000 cP. According to embodiments of the inventive concept, a method for manufacturing an eco-friendly secondary battery using water as a solvent may be provided.

The first slurry may be applied on each of a first surface 1a and a second surface 2a of a first separator SL1. The first slurry may be applied to a thickness of 50 μm to 350 μm. The first slurry may be applied to 95% or greater of the surface area of each of the first surface la and the second surface 2a of the first separator SL1. The application of the first slurry may include, for example, at least one of a gravure coater method, a small-diameter gravure coater method, a reverse roll coater method, a transfer roll coater method, a kiss coater method, a dip coater method, a knife coater method, an air doctor blade coater method, a blade coater method, a bar coater method, a die coater method, a screen printing method, and a spray coater method.

The first slurry may be dried. The water may be removed by the drying process. The drying process may be performed at approximately 80° C. to approximately 130° C. The drying process may include, for example, a reduced-pressure drying method, but is not limited thereto. As a result, a first active material layer AL1 may be formed on each of the first surface 1a and the second surface 2a of the first separator SL1. A first electrode layer EL1 may be formed.

After the first electrode layer EL1 is formed, a first tab TAB1 may be formed on the first active material layer AL1. The first tab TAB1 may be formed through thermal bonding. For example, the first tab TAB1 may include a tape in which a conductive filler and a polymer are mixed and applied on one surface or both surfaces of a metal foil. The polymer may include a polymer having a low melting point. That is, the first tab TAB1 may include a thermally reactive conductive polymer tape.

Due to the thermal bonding process, the polymer of the first tab TAB1 melts, so that the adhesion between the first tab TAB1 and the first active material layer AL1 may increase. The thermal bonding process may be performed under a pressure condition. As a result, the first tab TAB1 may be adhered deep inside the first active material AL1. The thermal bonding process may be performed at a pressure of approximately 1 MPa or greater and a temperature of approximately 100° C. or higher.

A plurality of first electrode layers EL1 may be formed, and then stacked together to form a first stack ST1.

A second slurry including a second active material AM2, a third binder BD3 including a polyvinyl alcohol-based polymer, a second conductive material CA2, a fourth binder BD4, and water as a solvent may be prepared. The second active material AM2 may have a content of 80 wt % to 98 wt % based on 100 wt % of the second slurry. The third binder BD3 may have a content of 0.1 wt % to 5 wt % based on 100 wt % of the second slurry. The fourth binder BD4 may have a content of 0.1 wt % to 5 wt % based on 100 wt % of the second slurry. The second conductive material CA2 may have a content of 0.1 wt % to 10 wt % based on 100 wt % of the second slurry. The second slurry may have a viscosity at room temperature (e.g., 25° C.) of 100 cP to 100,000 cP. According to embodiments of the inventive concept, a method for manufacturing an eco-friendly secondary battery using water as a solvent may be provided.

The second slurry may be applied on each of a third surface 3a and a fourth surface 4a of a second separator SL2. The second slurry may be applied to a thickness of 50 μm to 350 μm. The second slurry may be applied to 95% or greater of the surface area of each of the third surface 3a and the fourth surface 4a of the second separator SL2. The application of the second slurry may include the same method as that of the application of the first slurry.

The second slurry may be dried. The water may be removed by the drying process. The drying process may be performed at approximately 80° C. to approximately 130° C. The drying process may include, for example, a reduced-pressure drying method, but is not limited thereto. As a result, a second active material layer AL2 may be formed on each of the third surface 3a and the fourth surface 4a of the second separator SL2. A second electrode layer may be formed. After the second electrode layer is formed, a second tab TAB2 may be formed on the second active material layer AL2. The second tab TAB2 may be formed through thermal bonding. The formation of the second tab TAB2 may be substantially the same as the process of forming the first tab TAB1. A plurality of second electrode layers EL2 may be formed, and then stacked together to form a second stack ST2.

The first slurry may be applied of a fifth surface 5a of a third separator SL3. The second slurry may be applied of a sixth surface 6a of the third separator SL3. The first slurry and the second slurry may be dried. Due to the drying process, the water in the first slurry and the second slurry may be removed. The drying process may be performed at approximately 80° C. to approximately 130° C. The drying process may include, for example, a reduced-pressure drying method, but is not limited thereto. As a result, the first active material layer AL1 may be formed on the fifth surface 5a of the third separator SL3, and the second active material layer AL2 may be formed on the sixth surface 6a thereof. An intermediate electrode layer ML may be formed. A first tab TAB1 may be formed on a first active material layer AL1 of the intermediate electrode layer ML, and a second tab TAB2 may be formed on a second active material layer AL2 thereof. The formation of the first tab TABI and the second tab TAB2 on the intermediate electrode layer ML may be substantially the same as the above-described thermal bonding process.

The formation of the first electrode layer, the second electrode layer, and the intermediate electrode layer ML may be simultaneously performed, but is not limited thereto, and may be separately performed.

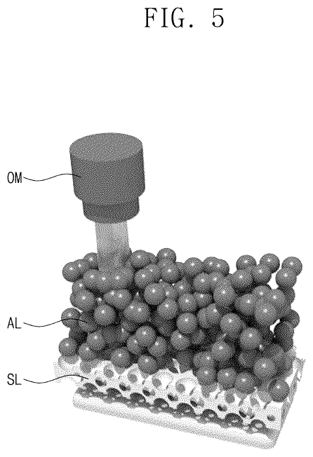

FIG. 4 is a cross-sectional view of a secondary battery according to some embodiments of the inventive concept. In order to simply the description, the same descriptions as those of the secondary battery described with reference to FIG. 1, FIG. 2A, FIG. 2B, FIG. 2C, and FIG. 3 will be omitted.

Referring to FIG. 4, a lithium metal ML may be used as a negative electrode. A first stack ST1 in which a plurality of first electrode layers EL1 are stacked may be used as a positive electrode. A first separator SL1 may be interposed between the lithium metal ML and the first stack ST1. The first stack ST1 may be the same as the first stack ST1 described with reference to FIG. 1, FIG. 2A, FIG. 2B, FIG. 2C, and FIG. 3.

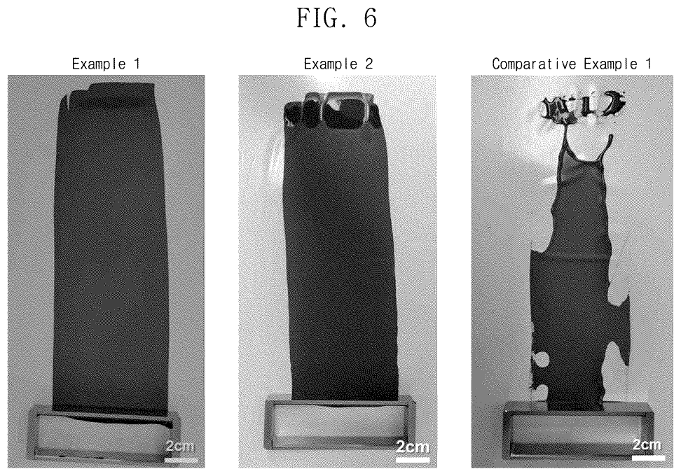

FIG. 5 is a schematic view of a secondary battery analysis platform according to some embodiments of the inventive concept. In order to simply the description, the same descriptions as those of the secondary battery described with reference to FIG. 1, FIG. 2A, FIG. 2B, FIG. 2C, and FIG. 3 will be omitted.

Referring to FIG. 5, an active material layer AL of the secondary battery according to embodiments of the inventive concept may be exposed to the outside. More specifically, the active material layer AL at the outermost periphery (uppermost portion and/or lowermost portion) may be exposed to the outside. The secondary battery according to embodiments of the inventive concept is in a form in which a metal current collector is omitted, wherein the active material layer AL at the outermost periphery may be exposed to the outside.

The secondary battery may be observed in real time through observation equipment OM. The exposed active material layer AL may be observed. The observation equipment OM may include, for example, an optical microscope, a Raman spectrometer, FT-IR, and XRD.

Hereinafter the inventive concept will be described with reference to Examples and Comparative Examples.

### Example 1

A polyolefin separator was prepared. Graphite was prepared as an active material. Polyvinyl alcohol was prepared as a first binder. Sodium carboxymethyl cellulose and styrene butadiene rubber were prepared as a second binder. The weight ratio of the graphite, the sodium carboxymethyl cellulose, the styrene butadiene rubber, and the polyvinyl alcohol was 95.5:1.5:1.5:1.5. After dissolving the first binder and the second binder, the active material, the first binder, the second binder, and water were mixed through a planetary mixer to prepare a slurry. The slurry was applied on the separator by means of a doctor blade.

### Example 2

A polyolefin separator was prepared. Graphite was prepared as an active material. Polyvinyl alcohol was prepared as a first binder. Sodium carboxymethyl cellulose and styrene butadiene rubber were prepared as a second binder. Carbon black was prepared as a conductive material. The weight ratio of the graphite, the sodium carboxymethyl cellulose, the styrene butadiene rubber, the polyvinyl alcohol, and the carbon black was 92.5:1.5:1.5:1.5:3. The rest of the process was the same as in Example 1.

### Example 3

A polyolefin separator was prepared. Graphite was prepared as an active material. Polyvinyl alcohol was prepared as a first binder. Styrene butadiene rubber was prepared as a second binder. Single-walled carbon nanotubes were prepared using a conductive material. The ratio of a long axis to a short axis of the conductive material was approximately 1000 to approximately 10000. The weight ratio of the graphite, the polyvinyl alcohol, the styrene butadiene rubber, and the single-walled carbon nanotubes was 96:1.5:1.5:1. After dissolving the first binder and the second binder, the active material, the first binder, the second binder, and water were mixed through a planetary mixer to prepare a slurry. The slurry was applied on the separator by means of a doctor blade. Thereafter, a drying process at 100° C. was performed for 1 hour to form an active material layer on the separator. Through the process, an electrode layer was formed.

### Example 4

A polyolefin separator was prepared. Graphite was prepared as an active material. Polyvinyl alcohol was prepared as a first binder. Styrene butadiene rubber was prepared as a second binder. Carbon black and single-walled carbon nanotubes were prepared as a conductive material. The ratio of a long axis to a short axis of the conductive material was approximately 1000 to approximately 10000. The weight ratio of the graphite, the polyvinyl alcohol, the sodium carboxymethyl cellulose, the carbon black, and the single-walled carbon nanotubes was 94:1.5:1.5:2:1. The rest of the process was the same as in Example 3.

### Example 5

The weight ratio of the graphite, the polyvinyl alcohol, the sodium carboxymethyl cellulose, the carbon black, and the single-walled carbon nanotubes was 92.5:1.5:3:1:2. The rest of the process was the same as in Example 3.

### Example 6

The weight ratio of the graphite, the polyvinyl alcohol, the sodium carboxymethyl cellulose, the styrene butadiene rubber, the carbon black, and the single-walled carbon nanotubes was 93.5:1.5:1.5:0.5:2:1. The rest of the process was the same as in Example 3.

### Example 7

The weight ratio of the graphite, the polyvinyl alcohol, the sodium carboxymethyl cellulose, the styrene butadiene rubber, the carbon black, and the single-walled carbon nanotubes was 94:1:1.5:0.5:2:1. The rest of the process was the same as in Example 3.

### Example 8

The weight ratio of the graphite, the polyvinyl alcohol, the sodium carboxymethyl cellulose, the styrene butadiene rubber, the carbon black, and the single-walled carbon nanotubes was 94:1:1.5:1:1.5:1. The rest of the process was the same as in Example 3.

### Comparative Example 1

A slurry not including a first binder was prepared. Graphite was prepared as an active material. Sodium carboxymethyl cellulose and styrene butadiene rubber were prepared as a second binder. The weight ratio of the graphite, the sodium carboxymethyl cellulose, and the styrene butadiene was 97:1.5:1.5. The rest of the process was the same as in Example 3.

### Comparative Example 2

An electrode layer not including a conductive material was formed. The weight ratio of graphite, polyvinyl alcohol, and sodium carboxymethyl cellulose was 97:1.5:1.5. The rest of the process was the same as in Example 3.

### Comparative Example 3

An electrode layer not including a high-aspect ratio conductive material was formed. Carbon black was prepared as a dot conductive material. The weight ratio of the graphite, the polyvinyl alcohol, the sodium carboxymethyl cellulose, the carbon black was 96:1.5:1.5:1. The rest of the process was the same as in Example 3.

### Comparative Example 4

An electrode layer not including a high-aspect ratio conductive material was formed. Carbon black was prepared as a dot conductive material. The weight ratio of the graphite, the polyvinyl alcohol, the sodium carboxymethyl cellulose, the carbon black was 94:1.5:1.5:3. The rest of the process was the same as in Example 3.

### Evaluation Example 1: Capturing Photographs

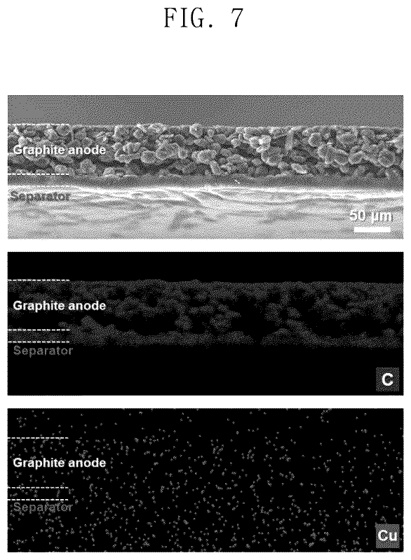

FIG. 6 illustrates the result of applying the slurry according to each of Example 1, Example 2, and Comparative Example 1 on a separator. In the case of Example 1 and Example 2, it can be confirmed that the slurry was uniformly applied by including the first binder containing polyvinyl alcohol. In addition, in the case of Example 2, it can be confirmed that the slurry was uniformly applied on the separator even when the conductive material was added in excess. In the case of Comparative Example 1, it can be confirmed that the binder was not uniformly applied because the first binder was not included.

### Evaluation Example 2: Energy Dispersive X-ray Spectroscopy

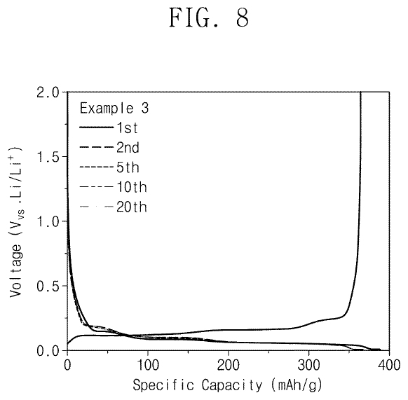

FIG. 7 shows the result of EDS capturing of an electrode layer according to Example 2. Referring to FIG. 7, it can be confirmed that an active material layer is formed on a separator.

### Evaluation Example 3: Electronic Conductivity Measurement

The electronic conductivity of each of the electrode layers of Examples 3, 4, 5, 6, 7, and 8 and Comparative Examples 2 and 3 was measured. The resistance of the electrode layer was evaluated by a 4-point measurement method, and the electronic conductivity was derived by reflecting an electrode structure factor.

TABLE 1

| | Electronic conductivity (S/cm) |
|---|---|
| Example 3 | 7.43 |
| Example 4 | 10.6 |
| Example 5 | 12.7 |
| Example 6 | 9.33 |
| Example 7 | 16.0 |
| Example 8 | 15.3 |
| Comparative | 1.07 |
| Example 2 | |
| Comparative | 6.03 |
| Example 3 | |

Referring to Table 1, it can be confirmed that Comparative Example 2 which does not contain a conductive material exhibits low electronic conductivity. When comparing Example 3 with Comparative Example 3, it can be confirmed that Example 3 which includes a high-aspect ratio conductive material has high electronic conductivity. When comparing Examples 4, 5, and 6 with Comparative Example 3, it can also be confirmed that when a high-aspect ratio conductive material is included, high electronic conductivity is exhibited.

### Evaluation Example 4: Adhesion Measurement

The adhesion between the active material and the separator of each of Examples 3, 4, 5, 6, 7, and 8 and Comparative Examples 2 and 3 was measured. The adhesion measurement was performed through an adhesion evaluation at 180° C. The force required to separate the active material layer from the separator was measured using a 1.2 cm wide tape, and then divided by the width to obtain a quantified numerical value, which is illustrated in Table 2.

TABLE 2

| | Adhesion (g/cm) |
|---|---|
| Example 3 | 140 |
| Example 4 | 225 |
| Example 5 | 206 |
| Example 6 | 225 |
| Example 7 | 229 |
| Example 8 | 216 |
| Comparative Example 2 | — |
| Comparative Example 3 | — |

Referring to Table 2, it can be confirmed that Examples 2 to 8 have higher adhesion due to the second binder. Furthermore, it can be confirmed that the binder facilitates contact between a particle and a particle, resulting in increasing the adhesion to some extent, the effect of which is greater in the carbon nanotubes.

### Evaluation Example 5: Charge/Discharge Characteristics 1

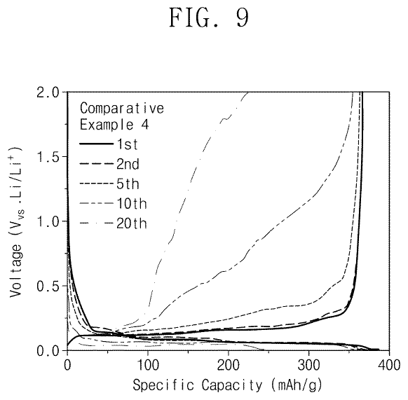

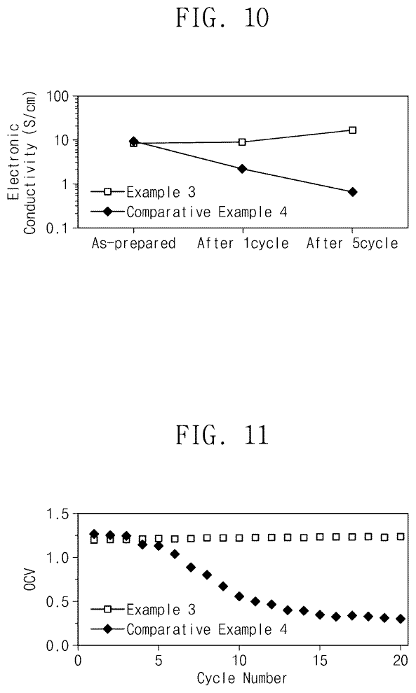

Half-cells were configured using the electrode layers of Example 3 and Comparative Example 4. Charge/discharge was performed under a 0.1 C rate condition. The results are respectively illustrated in FIG. 8 and FIG. 9. Referring to FIG. 8, it can be confirmed that charge/discharge stably continues in the case of Example 3. In addition, it can be confirmed that the negative electrode according to Example 3 implements a capacity equivalent to a theoretical capacity.

Referring to FIG. 9, it can be confirmed that the electrode layer of Comparative Example 4 gradually deviates from an initial charge/discharge curve and shows an irreversible result.

### Evaluation Example 6: Electronic Conductivity Evaluation According to Charge/Discharge

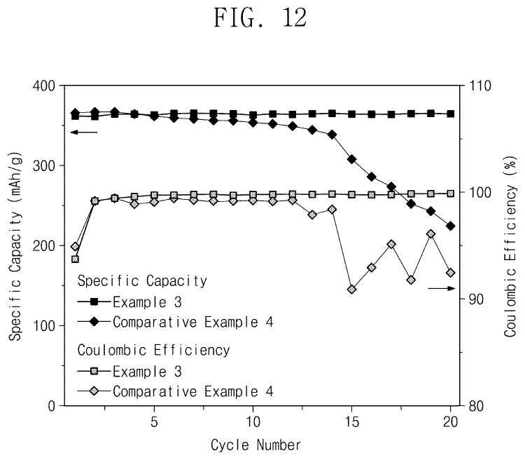

In order to confirm the deterioration in electronic conductivity due to charge/discharge under a 0.1 C rate condition, the result of measuring the electronic conductivity of Example 3 and Comparative Example 4 after performing the charge/discharge one time and 5 times is illustrated in FIG. 10. Referring to FIG. 10, it can be confirmed that the electronic conductivity of Comparative Example 4 is reduced unlike Example 3.

### Evaluation Example 7: Open Circuit Voltage Evaluation After Charge/Discharge

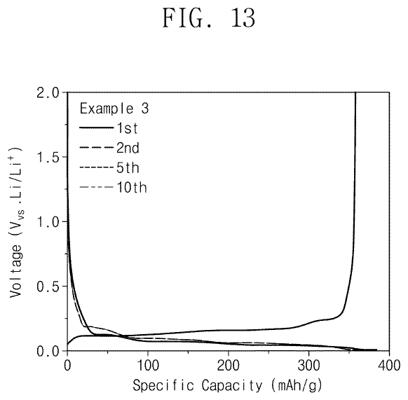

The open circuit voltage after performing charge/discharge under a 0.1 C rate condition on the electrode layers of Example 3 and Comparative Example 4 is illustrated in FIG. 11. Referring to FIG. 11, in the case of Comparative Example 4, it can be confirmed that the open circuit voltage is lowered due to lithium remaining irreversibly in the negative electrode layer.

### Evaluation Example 8: Capacity and Coulombic Efficiency for Charge/Discharge

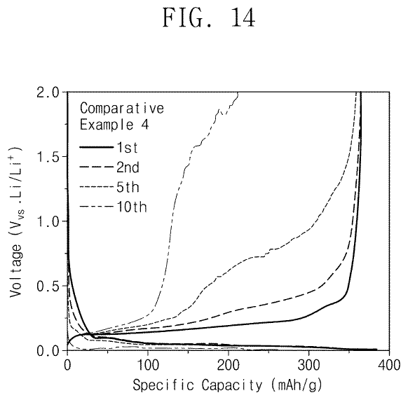

The capacity and the Coulombic efficiency for charge/discharge under a 0.1 C rate condition of the electrode layers of Example 3 and Comparative Example 4 are illustrated in FIG. 12. Referring to FIG. 12, it can be confirmed that the capacity and the Coulombic efficiency of Example 3 are better than those of Comparative Example 3.

### Evaluation Example 9: Charge/Discharge Characteristics 2

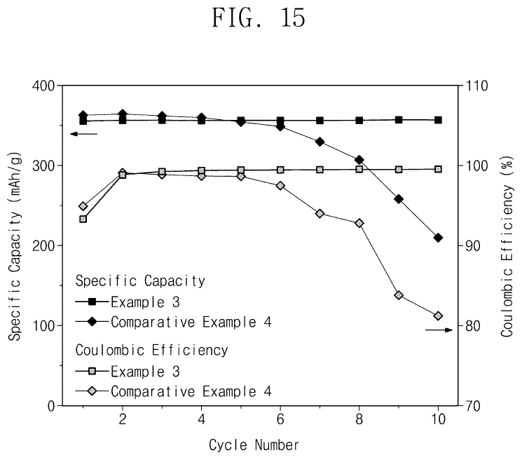

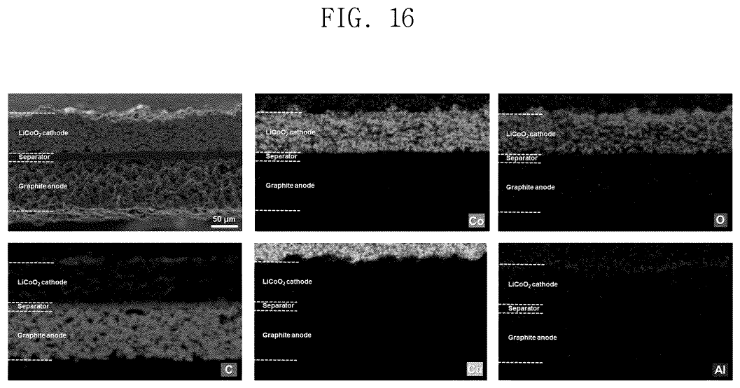

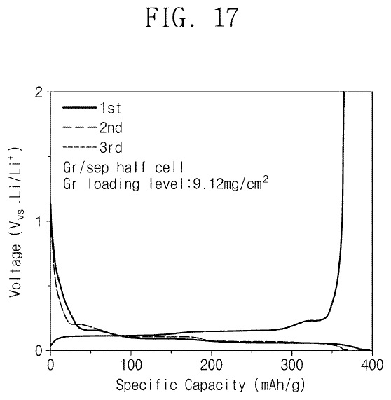

In order to confirm that the result of FIG. 7 is irrelevant to a charge/discharge rate, charge/discharge was performed at a 0.2 C rate on the electrodes of Example 3 and Comparative Example 4. The result according to the charge/discharge is illustrated in FIG. 13 and FIG. 14. Furthermore, the capacity and the Coulombic efficiency of Example 3 and Comparative Example 4 for the charge/discharge under the 0.2 C rate condition are illustrated in FIG. 15.

Referring to FIGS. 13, 14, and 15, it can be seen that the electrode deterioration occurring when a conductive material in a dot shape is used is irrelevant to a charge/discharge rate. That is, it can be confirmed that the electrode deterioration of Comparative Example 4 is irrelevant to the charge/discharge rate. With reference to FIG. 13 to FIG. 15, it can be confirmed that the greater the charge/discharge rate, the faster the electrode deterioration occurs.

### Evaluation Example 7: Energy Dispersive X-ray Spectroscopy

A negative electrode layer according to Example 7 was formed. A positive electrode layer was formed on the other surface of a separator on which the negative electrode layer was not formed. LiCoO₂ was prepared as a positive electrode active material. Polyvinyl alcohol was prepared as a first binder. Sodium carboxymethyl cellulose and styrene butadiene rubber were prepared as a second binder. Single-walled carbon nanotubes were prepared as a high-aspect ratio conductive material. Carbon black was prepared as a conductive material in a dot shape. The weight ratio of the LiCoO₂, the polyvinyl alcohol, the sodium carboxymethyl cellulose, the styrene butadiene rubber, the single-walled carbon nanotubes, and the carbon black was 93:1:0.75:1:0.5:3.75. These were mixed to prepare a slurry. The slurry was applied on the other surface of the separator and then dried. As a result, a positive electrode active material layer was formed on the other surface of the separator.

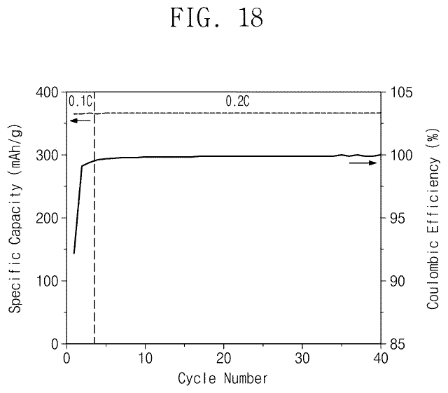

The result of capturing SEM and EDS of a cross-section of the positive electrode active material layer is illustrated in FIG. 16. Referring to FIG. 15, it can be seen that different types of active material layers are uniformly formed on both surfaces of the separator.

### Evaluation Example 8: Charge/Discharge Evaluation 3

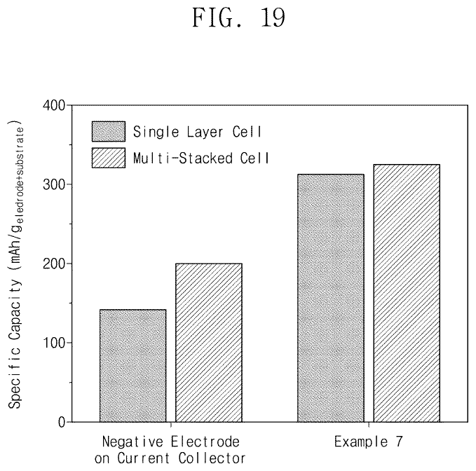

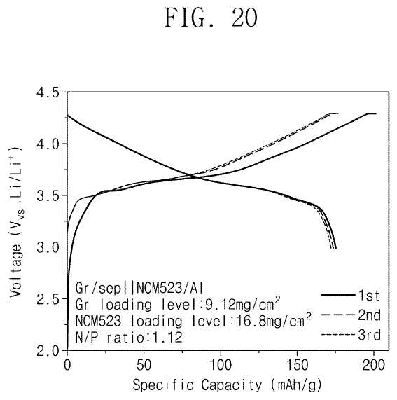

The results of evaluating the negative electrode layer having a loading amount of 9 mg/cm² in the electrode composition according to Example 7 are illustrated in FIG. 17 and FIG. 18. Charge/discharge was performed three times at a 0.1 C rate, and then charge/discharge was performed at a 0.2 C rate. FIG. 17 illustrates the results of three cycles of charge/discharge in curves. Referring to FIG. 17, it can be confirmed that the capacity equivalent to a theoretical capacity is implemented. Referring to FIG. 18, it can be confirmed that the capacity is stably expressed even when the number of times of performing charge/discharge increases.

### Evaluation Example 9: Energy Density Evaluation

The theoretical energy density of an electrode using a current collector and the energy density according to the electrode layer according to Example 7 were compared. The energy density of a negative electrode layer on a 15 μm-thick copper current collector assuming that all theoretical capacities were implemented and the energy density of the electrode layer according to Example 7 were compared.

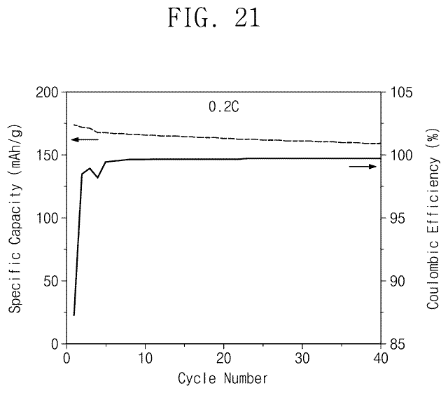

Referring to FIG. 19, when comparing Example 7 and the negative electrode layer on the current collector based on a multilayer and a single layer, it can be confirmed that the electrode layer according to Example 7 has excellent energy density. More specifically, in the case of the negative electrode using the current collector, it can be confirmed that the capacity values per weight are respectively 141 mAh/g and 201 mAh/g based on the single layer and the multilayer. It can be confirmed that the electrode layer according to Example 7 have 314 mAh/g and 328 mAh/g, respectively.

### Evaluation Example 10: Charge/Discharge Evaluation 4

The performance evaluation was performed by combining the electrode layer according to Example 7 with a positive electrode formed on a current collector. A negative electrode had a loading amount of 9 mg/cm² in the electrode composition according to Example 7. The positive electrode was formed on an aluminum current collector at a weight ratio of NCM523, carbon black, and a PVdF binder of 92:4:4. The N/P ratio was 1.12. Charge/discharge was performed three times at a 0.1 C rate, and then charge/discharge was performed at a 0.2 C rate.

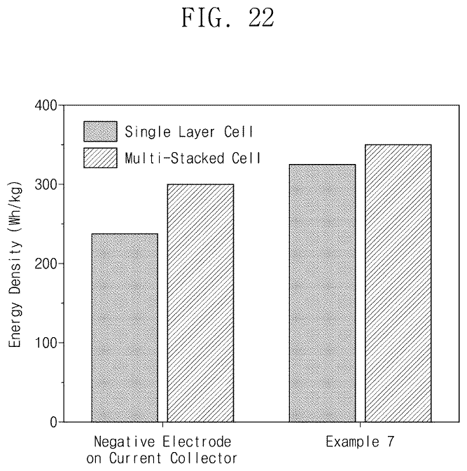

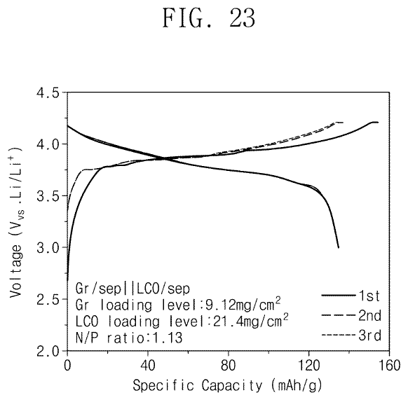

Referring to FIG. 20, it can be confirmed that the capacity equivalent to a theoretical capacity is implemented. Referring to FIG. 21, stable charge/discharge characteristics can be confirmed.

### Evaluation Example 11: Energy Density Evaluation 2

The performance evaluation was performed by combining the electrode layer according to Example 7 with a positive electrode formed on a current collector. A negative electrode had a loading amount of 9 mg/cm² in the electrode composition according to Example 7. The positive electrode was formed on an aluminum current collector at a weight ratio of NCM523, carbon black, and a PVdF binder of 92:4:4.

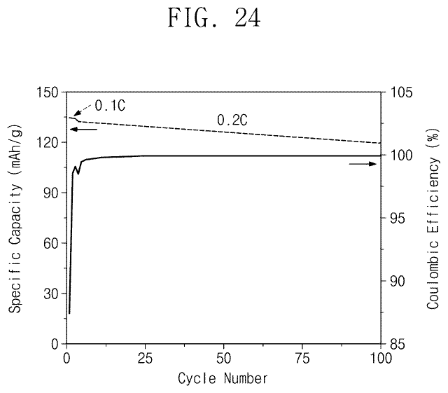

The energy density thereof was compared with that of a secondary battery using aluminum as a negative current collector and copper as a positive current collector assuming that all theoretical capacities were implemented. The negative electrode current collector and the positive electrode current collector each had a thickness of 15 μm. The energy density evaluation results are illustrated in FIG. 22.

Referring to FIG. 22, it can be confirmed that the battery using the current collector has 238 Wh/kg and 296 Wh/kg in the cases of a single layer and a multilayer, respectively. In the battery design according to Example 7, it can be confirmed that it is 328 Wh/kg and 351 Wh/kg. That is, it can be confirmed that the energy density of the battery according to Example 7 is excellent.

### Evaluation Example 12: Charge/Discharge Evaluation 4

A negative electrode having a loading amount of 9.12 mg/cm2 and a positive electrode having a loading amount of 21.4 mg/cm2 were respectively applied on both surfaces of a separator. Graphite was used as a negative electrode active material. LiCoO₂ was used as a positive electrode active material. As a result, a secondary battery having a positive electrode layer and an electrode layer and not including a current collector was manufactured. The battery was charged and discharged three times at a 0.1 C rate and then charged and discharged at a 0.2 C rate.

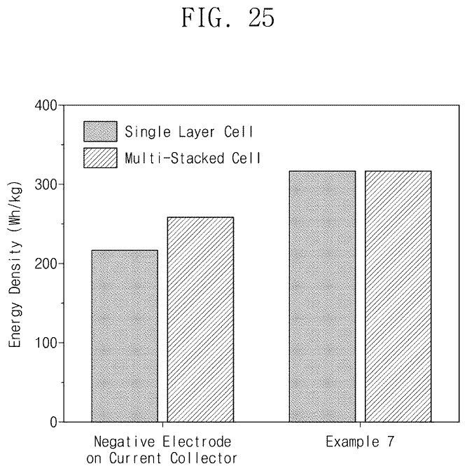

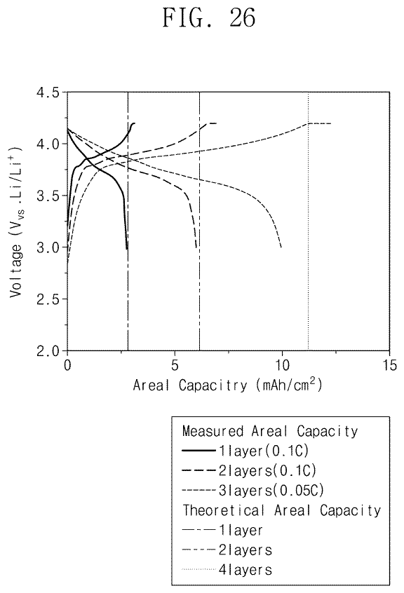

FIG. 23 illustrates curves of initial three cycles of charge/discharge. FIG. 24 illustrates capacity retention results. Referring to FIG. 23 and FIG. 24, it can be confirmed that the capacity equivalent to a theoretical capacity is maintained and that a stable capacity is maintained.

### Evaluation Example 13: Energy Density Evaluation 3

A negative electrode (graphite) having a loading amount of 9.12 mg/cm² and a positive electrode (LiCoO₂) having a loading amount of 21.4 mg/cm² were respectively applied on both surfaces of a separator. As a result, a secondary battery having a positive electrode layer and an electrode layer and not including a current collector was manufactured. The result of comparing the energy density thereof with that of a battery using a current collector is illustrated in FIG. 24.

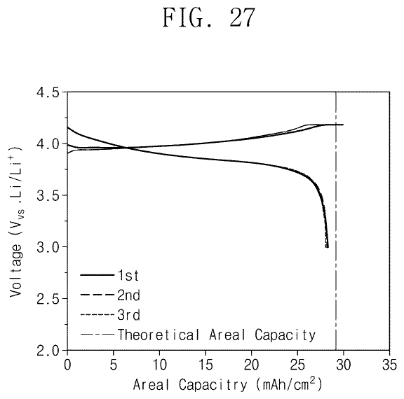

Referring to FIG. 25, it can be confirmed that the battery using a current collector has an energy density of 213 Wh/kg and 260 Wh/kg based on a single layer and a multilayer, respectively. It can be confirmed that the battery not including a current collector has an energy density of 318 Wh/kg. Therefore, it can be confirmed that the energy density of the current collector according to the embodiment is high.

### Evaluation Example 14: Stacked-Type Secondary Battery Characteristics Evaluation 1

A negative electrode layer according to Example 7 was formed in plurality, and then stacked together to form a first stack.

A positive electrode layer was separately formed. LiCoO₂ was prepared as a positive electrode active material. Polyvinyl alcohol was prepared as a first binder. Sodium carboxymethyl cellulose and styrene butadiene rubber were prepared as a second binder. Single-walled carbon nanotubes were prepared as a high-aspect ratio conductive material. Carbon black was prepared as a conductive material in a dot shape. The weight ratio of the LiCoO₂, the polyvinyl alcohol, the sodium carboxymethyl cellulose, the styrene butadiene rubber, the single-walled carbon nanotubes, and the carbon black was 93:1:0.75:1:0.5:3.75. These were mixed to prepare a slurry. The slurry was applied on a separate separator and then dried. As a result, a positive electrode layer was formed. The positive electrode layer was formed in plurality and then stacked together to form a second stack. The first stack and the second stack were stacked together to configure a secondary battery.

More specifically, the first stack was formed by stacking one, two, and four negative electrode layers, respectively. The second stack was formed by stacking one, two, and four positive electrode layers, respectively. The first stack and the second stack were stacked to configure a secondary battery.

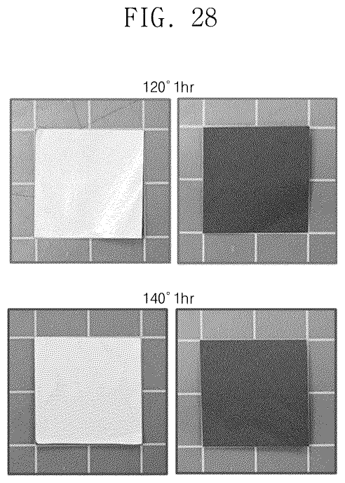

Referring to FIG. 26, the result of charging and discharging the secondary battery is illustrated. In the case of a battery in which an active material layer is stacked in four layers, it can be confirmed that it is possible to implement a capacity per area of approximately 10 mAh/cm².

### Evaluation Example 15: Stacked-Type Secondary Battery Characteristics Evaluation 2

LiCoO₂ was prepared as a positive electrode active material. Polyvinyl alcohol was prepared as a first binder. Sodium carboxymethyl cellulose and styrene butadiene rubber were prepared as a second binder. Single-walled carbon nanotubes were prepared as a high-aspect ratio conductive material. Carbon black was prepared as a conductive material in a dot shape. The weight ratio of the LiCoO₂, the polyvinyl alcohol, the sodium carboxymethyl cellulose, the styrene butadiene rubber, the single-walled carbon nanotubes, and the carbon black was 93:1:0.75:1:0.5:3.75. These were mixed to prepare a slurry. The slurry was applied on both surfaces of a separator and then dried. As a result, a positive electrode layer was formed. Five of the positive electrode layers were formed and then stacked together. A lithium metal was used as a negative electrode layer. As a result, a secondary battery was configured.

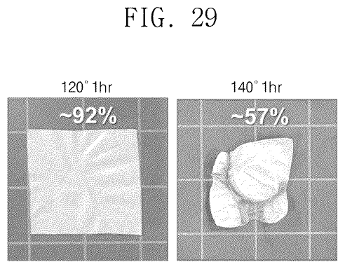

Charge/discharge results of the secondary battery were illustrated in FIG. 27. Referring to FIG. 27, it can be confirmed that a capacity equivalent to a theoretical capacity is implemented. It can be confirmed that the secondary battery has a capacity per area of 27 mAh/cm².

### Evaluation Example 16: Evaluation of Thermal Stability

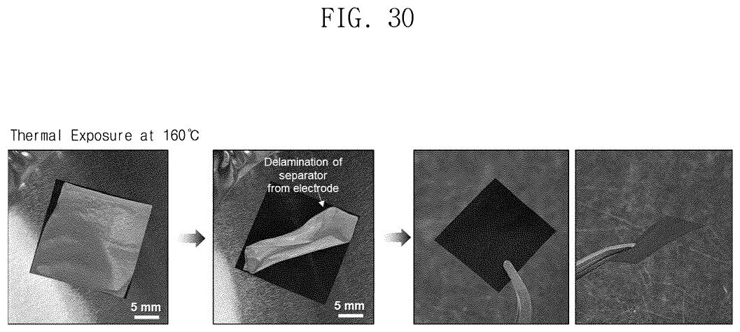

The degree of deformation was evaluated after exposing the electrode layer according to Example 7 to 120° C. and 140° C. for 1 hour. The results are illustrated in FIG. 28.

The degree of deformation was evaluated after exposing the separator according to Example 7 and not applied with a slurry to 120° C. and 140° C. for 1 hour. The results are illustrated in FIG. 29.

Referring to FIG. 28 and FIG. 29, it can be confirmed that the separator applied with an active material did not shrink even under the conditions of 140° C. and 1 hour, but it can be confirmed that a typical separator shrank by 8% when exposed to 120° C. for 1 hour, and shrank by 43% when exposed to 140° C. for 1 hour. As a result, it can be confirmed that an electrode layer applied on a separator contributes to the thermal stability of the separator.

### Evaluation Example 17: Separation Evaluation

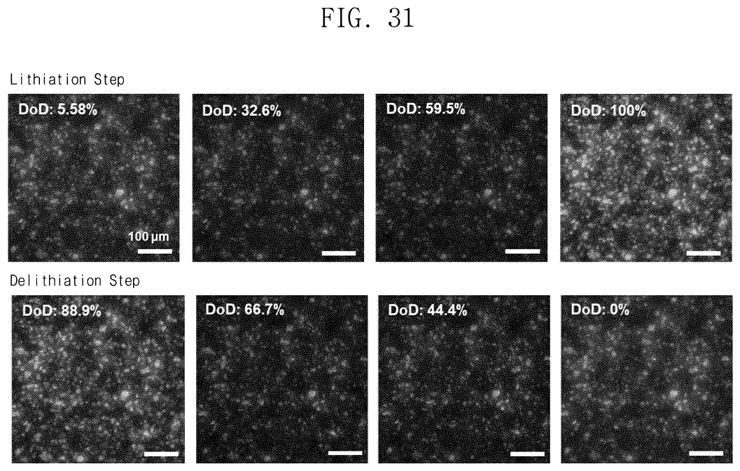

The electrode layer according to Example 7 was exposed to 160° C. The results are illustrated in FIG. 30. Referring to FIG. 30, it can be confirmed that the separator and the active material layer are separated from each other at 160° C.

### Evaluation Example 18: Analysis System

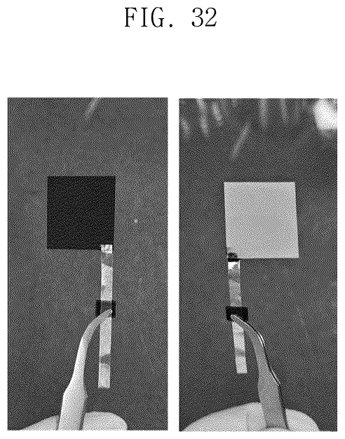

A half-cell was configured using the electrode layer according to Example 7 and a lithium metal. The half-cell was placed in a transparent case. Thereafter, processes of lithiation and delithiation of a negative electrode active material were observed using an optical microscope during charge/discharge. The results are illustrated in FIG. 31.

Referring to FIG. 31, as the processes progressed, graphite particles gradually changed to purple and yellow, which was observed with spatial resolution, and during the delithiation process, the color change in the reverse order of the lithiation process was observed.

### Evaluation Example 19

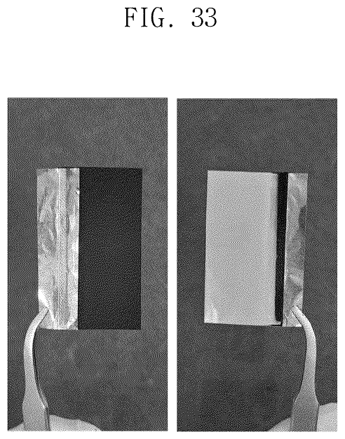

A tab was formed on the electrode layer according to Example 7. An electrode to which a carbon tape was attached was used as the tap. The tab was attached on the electrode layer, and then pressed with 5 MPa at a temperature of 180° C. for 5 seconds. The results are illustrated in FIG. 32 and FIG. 33.

Referring to FIG. 32 and FIG. 33, it can be seen that the tab was stably formed on the active material layer.

According to embodiments of the inventive concept, a secondary battery not including a current collector may be provided. Since a metal current collector occupying a large volume and a large weight is not included, a lightweight secondary battery may be provided, and a secondary battery having improved energy density may be provided.

According to embodiments of the inventive concept, a separator and an active material layer may be easily separated from each other at a critical temperature or higher. An easily recyclable secondary battery may be provided.

According to embodiments of the inventive concept, water may be used as a solvent of a slurry for preparing an active material layer. Therefore, a method for manufacturing an eco-friendly secondary battery may be provided.

Although the embodiments of the inventive concept have been described with reference to the accompanying drawings, those skilled in the art will appreciate that the present invention can be variously modified and changed without departing from the spirit and scope of the present invention as set forth in the following patent claims. In addition, the embodiments disclosed herein are not intended to limit the technical spirit of the present invention, and all technical concepts falling within the scope of the following claims and equivalents thereof are to be construed as being included in the scope of the inventive concept.

What is claimed is:

1. An electrode layer comprising:
a hydrophobic separator comprising a first surface and a second surface opposite to each other;
a first active material layer on the first surface of the separator; and
a second active material layer on the second surface of the separator,
wherein the first active material layer comprises:
a first active material;
a first binder comprising a polyvinyl alcohol-based polymer;
a second binder being hydrophilic comprising a material different from that of the first binder; and
a first conductive material having a ratio of the length of a long axis to the length of a short axis of 2 or greater, and
the second active material layer comprises:
a second active material;
a third binder comprising a polyvinyl alcohol-based polymer;
a fourth binder being hydrophilic and comprising a material different from that of the third binder; and
a second conductive material having a ratio of the length of a long axis to the length of a short axis of 2 or greater, and
the electrode layer does not include a metal current collector.

2. The electrode layer of claim 1, wherein an electronic conductivity of each of the first active material layer and the second active material layer is approximately 5 S/cm or greater.

3. The electrode layer of claim 1, wherein each of the second binder and the fourth binder comprises one or more selected from the group consisting of polyethylene oxide (PEO), polyvinyl pyrrolidone (PVP), polyacrylamides, poly N-(2-Hydroxypropyl) methacrylamide (HPMA), polyethyleneimine (PEI), polyacrylic acid (PAA), divinyl ether-maleic anhydride, polyoxazoline, polyphosphates, polyphosphazenes, xanthan gum, pectins, dextran, carrageenan, guar gum, sodium carboxymethyl cellulose, styrene-butadiene rubber, sodium alginate, hyaluronic acid, albumin, and a combination thereof.

4. The electrode layer of claim 1, wherein the separator comprises a polyolefin-based polymer.

5. The electrode layer of claim 1, wherein a content of the first conductive material is 0.1 wt % to 10 wt % based on 100 wt % of the first active material layer.

6. The electrode layer of claim 1, wherein the first conductive material comprises one or more selected from the group consisting of carbon nanotubes, graphene, graphite, and a combination thereof.

7. The electrode layer of claim 1, wherein a content of the second binder is 0.1 wt % to 5 wt % based on 100 wt % of the first active material layer.

8. The electrode layer of claim 1, wherein a thickness of each of the first active material layer and the second active material layer is 50 μm to 350 μm.

9. The electrode layer of claim 1, wherein a capacity per unit area of each of the first active material layer and the second active material layer is 4 mAh/cm².

10. The electrode layer of claim 1, wherein a content of the first active material is 80 wt % to 98 wt % based on 100 wt % of the first active material layer.

11. An electrode layer comprising:
a first separator comprising a first surface and a second surface opposite to each other; and
a plurality of first active material layers on the first surface and the second surface of the first separator,
wherein each of the plurality of first active material layers comprises:
a first binder comprising a first active material and a polyvinyl alcohol-based polymer;
a second binder comprising a material different from that of the first binder; and
a first conductive material having a ratio of the length of a long axis to the length of a short axis of approximately 2 or greater, and
the electrode layer does not include a metal current collector.

12. The electrode layer of claim 11, wherein the first active material comprises a lithium transition metal oxide.

13. The electrode layer of claim 11, wherein the first separator comprises a polyolefin-based polymer.

14. The electrode layer of claim 11, further comprising a first tab disposed on each of the plurality of first active material layers.

15. A method for manufacturing a secondary battery comprising:
preparing a first slurry comprising a first active material, a first binder comprising a polyvinyl alcohol-based polymer, a first conductive material, and a second binder;
preparing a second slurry comprising a second active material, a third binder comprising a polyvinyl alcohol-based polymer, a second conductive material, and a fourth binder;
applying the first slurry on a first surface of a separator;
applying the second slurry on a second surface of the separator;
drying the first slurry, thereby forming a first active material layer; and
drying the second slurry, thereby forming a second active material layer,
wherein each of the first conductive material and the second conductive material has a ratio of the length of a long axis to the length of a short axis of approximately 2 or greater.

16. The method of claim 15, wherein:
a content of the first conductive material is 0.1 wt % to 10 wt % based on 100 wt % of the first slurry; and
a content of the second conductive material is 0.1 wt % to 10 wt % based on 100 wt % of the second slurry.

17. The method of claim 15, wherein:
a content of the second binder is 0.1 wt % to 0.5 wt % based on 100 wt % of the first slurry; and
a content of the fourth binder is 0.1 wt % to 0.5 wt % based on 100 wt % of the second slurry.

18. The method of claim 15, wherein the first slurry and the second slurry are dried at 80° C. to 130° C.

19. The method of claim 15, wherein the first slurry and the second slurry each have a viscosity of 100 cP to 100,000 cP.

20. The method of claim 15, wherein:
the first binder is physically adsorbed onto the first surface of the separator; and
the third binder is physically adsorbed onto the second surface of the separator.
